(19) United States
(12) Patent Application Publication
(10) Pub. No.: US 2026/0031355 A1
(43) Pub. Date: Jan. 29, 2026

(54) ANODE COMPOSITION CONTAINING ANIONIC BINDER

(71) Applicant: COATEX, Genay (FR)

(72) Inventors: Benoît MAGNY, Fontaines Saint Martin (FR); Guillaume MICHAUD, Lyon (FR); Jean-Marc SUAU, Lucenay (FR)

(73) Assignee: COATEX, Genay (FR)

(21) Appl. No.: 18/992,315

(22) PCT Filed: Jul. 10, 2023
(86) PCT No.: PCT/FR2023/000132

§ 371 Date: Jan. 8, 2025

(30) Foreign Application Priority Data
Aug. 3, 2022 (FR) 2208068

(51) Int. Cl. H01M 4/62; H01M 4/02; H01M 4/04; H01M 4/1393; H01M 4/1395; H01M 4/38; H01M 4/583; H01M 10/0525

(52) U.S. Cl. CPC H01M 4/622; H01M 4/0404; H01M 4/0435; H01M 4/1393; H01M 4/1395; H01M 4/386; H01M 4/583; H01M 2004/021; H01M 2004/027; H01M 10/0525

(57) ABSTRACT

An aqueous anode composition including metal particles or fibres or carbon graphite particles or fibres, and a binding agent including at least one water-soluble polymer P prepared on the basis of (meth)acrylic acid and (meth)acrylate. A method for producing an anode including said aqueous composition.

The invention relates to an aqueous anode composition comprising metal or carbon graphite particles or fibres and a binding agent comprising at least one water-soluble anionic copolymer P that is prepared from (meth)acrylic acid and from (meth)acrylate. The invention also relates to a method for producing an anode using said aqueous composition. There are known anode compositions that generally comprise carbon or a metal in the form of particles associated with a binding composition. This binding composition must be able to effectively bind the carbon or the metal to a substrate to form an anode. The most common binding compositions comprise a styrene-butadiene polymer. The composition makes it possible to fix the particles on a metal substrate. The binding property is therefore decisive when producing an anode using these anode compositions. In addition, mechanical strength or electrochemical resistance is particularly sought.

Easy, uniform application of anode compositions is necessary in order to obtain a uniform layer and to limit or avoid flaws on the surface of the anode, resulting in a uniform and particularly effective conductive layer.

Generally, binding compositions also comprise various additives such as thickening agents, dispersing agents, for example a cellulose derivative. The most common cellulose derivatives are carboxymethylcellulose, hydroxyethyl cellulose and hydroxy methylcellulose.

These anode compositions frequently comprise silicon in order to increase the capacity of the prepared anodes. During the charging-discharging cycles of the batteries containing these anodes, it is usual to observe a strain that can lead to irreversible alteration of the anode, particularly as a result of the increase in the volume of the silicon. Strain tolerance is therefore also a desirable property.

It should be possible to reduce the number of ingredients used when preparing anode compositions.

The compatibility of the different ingredients of the anode compositions is also an important factor when preparing anode compositions as well as when preparing anodes using these compositions.

Document EP 2680349 relates to the preparation of a secondary battery anode using a polyacrylic binding agent. Document EP 2592679 describes a binding agent for secondary battery electrodes comprising water-insoluble copolymer particles with an average diameter ranging from 0.3 μm to 0.7 μm. Document EP 3001487 discloses a water-insoluble core-shell binding agent for a secondary battery electrode in which the core comprises styrene-butadiene rubber and the shell comprises a poly(styrene-acrylate) copolymer.

The anode compositions in the prior art are not always satisfactory. There is thus a need for anode compositions that provide solutions to all or part of the problems of the anode compositions in the prior art.

Thus, the Invention Provides an Aqueous Anode Composition T Comprising:
from 0.5% to 15% by dry weight of at least one binding agent L comprising at least one water-soluble polymer P, with a weight-average molecular mass Mw (measured by SEC) ranging from 2,000 g/mol to 1,000,000 g/mol, prepared in the presence of at least one initiator compound, by a polymerisation reaction of:
   a. from 20 to 95% by weight of at least one anionic monomer (a) chosen among acrylic acid, an acrylic acid salt, methacrylic acid, a methacrylic acid salt and combinations thereof;
   b. from 5 to 80% by weight of at least one C₁-C₈ ester (b) of a compound derived from an acid chosen among acrylic acid, methacrylic acid, maleic acid, itaconic acid and crotonic acid, relative to the total amount by weight of monomers (a) and (b); and
from 85% to 99.5% by dry weight of at least one material E chosen among metal fibres, metal particles, carbon graphite fibres, carbon graphite particles, silicon particles and combinations thereof, relative to the total amount by dry weight of binding agent L and of material E.

Essentially for the invention, the polymer P is prepared using the monomers a and b.

Preferably according to the invention, the anionic monomer (a) can be chosen among acrylic acid, methacrylic acid and combinations thereof; preferably the anionic monomer (a) is acrylic acid. Also preferably according to the invention, the monomer (a) can be combined with at least one other anionic monomer, different from the monomer (a), and chosen among acrylic acid, methacrylic acid, an acrylic acid salt, a methacrylic acid salt, maleic acid, a maleic acid salt, itaconic acid, an itaconic acid salt, crotonic acid, a crotonic acid salt, an acrylic acid oligomer and combinations thereof.

Preferably according to the invention, the ester (b) is a C₁-C₇ ester or a C₁-C₆ ester or a C₁-C₄ ester, preferably a C₁-C₃ ester. More preferably according to the invention, the ester (b) is an acrylic acid ester or a methacrylic acid ester, preferably an acrylic acid ester.

Also preferably according to the invention, the ester (b) is chosen among methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate and combinations thereof. More preferentially, the ester (b) is chosen among ethyl acrylate, methyl acrylate, butyl acrylate, methyl methacrylate and combinations thereof.

Generally, the ester (b) is not an alicyclic C₁-C₈ ester.

Advantageously according to the invention, a single polymerisation reaction is carried out.

Preferably according to the invention, the polymerisation reaction can also use at least one cross-linking monomer (c) or at least one monomer (c) comprising at least two olefinic unsaturations. More preferably, the monomer (c) is chosen among polyvinyl aromatic monomers (for example divinylbenzene and diallyl phthalate); polyalkenyl ethers (for example triallyl pentaerythritol, diallyl pentaerythritol, diallyl sucrose, octa allyl sucrose, trimethylolpropane diallyl ether); polyunsaturated esters of polyalcohols or polyunsaturated esters of polyacids (for example trimethylolpropane tri(meth)acrylate, trimethylolpropane, polyethylene glycol di(meth)acrylates); diacrylic esters, dimethacrylic esters derived from polyols chosen in particular among pentaerythritol, sorbitol, sucrose; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl(meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene; diallyl phthalate (DAP); ethylene glycol dimethacrylate (EGDMA); methylene bis acrylamide (MBA); divinylbenzene (DVB); bicyclopentenyloxyethyl-methacrylate (FRA); trimethylol propane triallyl ether (APE) and combinations thereof. More preferentially according to the invention, the monomer (c) can be chosen among diallyl phthalate (DAP); ethylene glycol dimethacrylate (EGDMA), trimethylolpropane diacrylate, trimethylolpropane dimethacrylate and combinations thereof.

Preferably, less than 5% by weight, preferably from 0.01 to 4% by weight, particularly from 0.02 to 4% by weight or from 0.02 to 2% by weight, in particular from 0.02 to 10% by weight, of monomer (c) can be used relative to the total amount by weight of monomers.

Also preferably according to the invention, the polymerisation reaction can use at least one hydrophobic monomer (d) different from compound (c). Preferably, the monomer (d) is a compound of formula (I):

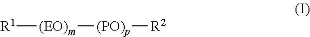

wherein:
   m and p, identical or different, independently represent 0 or an integer or decimal less than 150, m or p is different from 0,
   EO independently represents a CH₂CH₂O group,
   PO independently represents a group chosen among CH(CH₃)CH₂O and CH₂CH(CH₃)O,
   R¹ independently represents a group comprising at least one polymerisable olefinic unsaturation, preferably an acrylate group or a methacrylate group and
   R² independently represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group, or a group comprising 2 to 5 phenyls or a tristyrylphenyl group or a pentastyrylcumylphenyl group. Also preferably, less than 20% by weight, preferably from 0.05 to 20% by weight, in particular from 0.1 to 10% by weight, of monomer (d) can be used relative to the total amount by weight of monomers.

Also preferably according to the invention, the polymerisation reaction can use at least one compound (e) chosen among phosphated hydroxyethyl acrylate, phosphated hydroxypropyl acrylate, phosphated hydroxyethyl hexyl acrylate, phosphated hydroxyethyl-methacrylate, phosphated hydroxypropyl-methacrylate, phosphated hydroxyethyl hexyl-methacrylate, their salts and combinations thereof.

Also preferably, less than 20% by weight, preferably from 0.2 to 20% by weight, in particular from 0.5 to 10% by weight, of monomer (e) can be used relative to the total amount by weight of monomers.

Also preferably according to the invention, the polymerisation reaction can use at least one compound (f) chosen among hydroxyethyl-acrylate, hydroxypropyl-acrylate, hydroxy ethyl hexyl-acrylate, hydroxyethyl-methacrylate, hydroxypropyl-methacrylate, hydroxy ethyl hexyl-methacrylate.

Also preferably, less than 20% by weight, preferably from 0.2 to 20% by weight, in particular from 0.5 to 10% by weight, of monomer (f) can be used relative to the total amount by weight of monomers.

Also preferably according to the invention, the polymer P is prepared using a combination of monomers a and b, a combination of monomers a, b and c, a combination of monomers a, b and d, a combination of monomers a, b and e, a combination of monomers a, b and f, a combination of monomers a, b, c and d, a combination of monomers a, b, c and e, a combination of monomers a, b, c and f, a combination of monomers a, b, c, d and e, a combination of monomers a, b, c, d and f, a combination of monomers a, b, d and e, a combination of monomers a, b, d and f, a combination of monomers a, b, e and f, a combination of monomers a, b, c, d, e and f. More preferably according to the invention, the polymer P is prepared using a combination of monomers a and b alone.

When preparing the polymer P of the invention, monomers a and b are therefore essential.

Monomers c, d, e and f can therefore be optionally used. In the absence of monomers c, d, e and f, the polymer P is prepared from monomers a and b alone.

Moreover, the polymer P can be prepared without certain monomers. In particular, the polymer P is prepared in the absence of organosulphur monomers, such as sulphonated monomers or sulphated monomers. In this case, the particular organosulphur monomers that are not used are chosen among 2-acrylamido-2-methylpropane sulphonic acid (AMPS), allyl sulphonic acid, alkylenesulphonates, alkylenearylsulphonates, in particular styrene sulphonate, vinyl sulphonate, methallyl sulphonate, allyl sulphonate, methallyl sulphate, allyl sulphate, 2-sulphoethyl methacrylate, 3-allyloxy-2-hydroxy-1-propanesulphonic acid, 3-sulphopropyl methacrylate, their salts and combinations thereof.

Other monomers can be excluded from the preparation of the polymer P, particularly a (meth)acrylamide monomer, an (acrylo)nitrile monomer, a fluorinated monomer, an acetate monomer, an imide monomer. Preferably according to the invention, the polymer P is prepared in the absence of halogenated monomer, in particular in the absence of fluorinated monomer.

When Preparing the Polymer P, the Proportions of Monomers a and b can Vary Considerably. Preferably According to the Invention, the Polymerisation Reaction Uses:
from 30 to 70% by weight, preferably from 35 to 70% by weight, of monomer (a) or
from 30 to 70% by weight, preferably from 30 to 65% by weight, of monomer (b), relative to the total amount by weight of monomers (a) and (b).

According to the invention, the copolymer P is water-soluble. Preferably according to the invention, the water-soluble copolymer P is prepared using a majority amount by weight of anionic monomers. Advantageously, the polymer P is soluble in any amount of water at room temperature, preferably at different pH values, particularly at pH values ranging from 2 to 12.

Preferably according to the invention, the pH of the polymer P is less than 12 or less than 11 or ranges from 2 to 12 or from 5 to 11. Also preferably according to the invention, the pKa of the polymer P is less than 5 or ranges from 1.5 to 5.

Preferably according to the invention, the polymerisation reaction is carried out at a temperature above 30° C. and below 130° C., preferably below 100° C. or below 90° C. or below 80° C. or below 75° C. Preferably during the polymerisation reaction to prepare the polymer P, the initiator compound is chosen among a peroxide (for example hydrogen peroxide), a hydroperoxide (for example tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof.

Preferably according to the invention, the polymer P is prepared in a polar solvent, in particular a solvent chosen among water, alcohol, toluene, a ketone, a chlorinated solvent, an ester and combinations thereof.

Also preferably according to the invention, the polymer P can be prepared in the presence of a chain transfer agent, preferably in the presence of a compound chosen among isopropyl alcohol, mercaptan, dodecyl-mercaptan, phosphorous acid, phosphite, hypophosphorous acid, hypophosphite, bisulphite, an alkyl iodide, an alkyl bromide and combinations thereof.

According to the invention, the polymer P can be non-neutralised or it can be partially neutralised or completely neutralised. Preferably, the polymer P is non-neutralised or partially neutralised. According to the invention, the carboxyl groups of the polymer P can be partially neutralised at a rate of 70 to 97 mol %, preferably at a rate of 90 to 95 mol %.

The polymer P can be partially or completely neutralised using at least one monovalent ion or at least one divalent ion. According to the invention, the polymer P can be partially or completely neutralised using a combination of at least one monovalent ion and of at least one divalent ion. According to the invention, the polymer P can thus be completely or partially neutralised in variable relative molar proportions of monovalent and divalent ions.

Preferably according to the invention, the monovalent ion/divalent ion molar proportions are comprised between 90/10 and 10/90 or between 80/20 and 20/80, preferably between 80/20 and 60/40, for example 70/30 or 50/50.

According to the invention, neutralisation can be carried out using a primary amine, a secondary amine or a monovalent ion chosen among K⁺, Na⁺, Li⁺, NH₄⁺ or an amine and combinations thereof. The preferred monovalent ion is chosen among Na⁺ and Li⁺. The polymer P according to the invention can nevertheless be neutralised in the absence of Li⁺ ion. According to the invention, neutralisation can also be carried out using a divalent ion chosen among Ca²⁺, Zn²⁺, Mg²⁺ and combinations thereof. The preferred divalent ion is Ca²⁺.

According to the invention, the polymer P can be neutralised using at least one compound chosen among NaOH, KOH, LiOH, ammonium derivatives, ammonia, ammonium hydroxide, primary amine, secondary amine, CaO, Ca(OH)₂, ZnO, Zn(OH)₂, MgO, Mg(OH)₂ and combinations thereof. Neutralising the polymer P using ammonia is particularly advantageous when using the composition T at a pH of less than 7, preferably at a pH of less than 5. According to the invention, the polymer P can be completely or partially neutralised using an amine base, for example a base chosen among ethylene diamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, triethanolamine, aminomethylpropanol or 2-amino-2-methylpropanol (AMP) and combinations thereof.

Preferably, the polymer P has a weight-average molecular mass Mw (measured by SEC) of less than 900,000 g/mol, less than 800,000 g/mol, less than 500,000 g/mol, more preferentially less than 350,000 g/mol. The polymer P generally has a weight-average molecular mass Mw (measured by SEC) greater than 5,000 g/mol, preferably greater than 20,000 g/mol.

The polymer P generally has a polymolecularity index PI (measured by SEC) of less than 4 or ranging from 1.2 to 4 or from 1.5 to 4; from 1.2 to 3 or from 1.5 to 3; from 1.2 to 2.5 or even from 1.5 to 2.5.

According to the invention, the molecular weight or mass of the polymer P is determined by Size Exclusion Chromatography (SEC). A test portion of the polymer solution corresponding to 90 mg of dry solids content is placed into a 10 mL flask. Mobile phase is added, together with 0.04% of dimethylformamide (DMF), until a total mass of 10 g is reached. The composition of this mobile phase is as follows: NaHCO₃: 0.05 mol/L, NaNO₃: 0.1 mol/L, triethanolamine: 0.02 mol/L, NaN₃ 0.03% by mass. The SEC chain is composed of a Waters 510 isocratic pump with a flow rate set to 0.8 mL/min, a Waters 717+ sample changer, an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standards Service with a molecular weight at the top of the peak comprised between 1,000 g/mol and 1.10⁶ g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using “PSS WinGPC Scientific” software v 4.02. The chromatogram obtained is incorporated into the area corresponding to molecular weights of more than 250 g/mol.

Generally according to the invention, the binding agent L comprises the polymer P in the form of particles.

Preferably according to the invention, the binding agent L comprises from 5% by weight to 100% by weight, preferably from 10% by weight to 70% by weight of polymer P.

Essentially according to the invention, the aqueous composition T comprises at least one binding agent L. Advantageously, the composition T according to the invention can comprise no other binding agent. Also advantageously, the composition T according to the invention can also comprise at least one other binding agent, different from agent L, preferably another binding agent chosen among a (meth)acrylic polymer, a comb polymer, carboxymethylcellulose, hydroxyethyl cellulose, hydroxymethyl cellulose, alginate, styrene-butadiene polymer, poly(allylamine, HCl), amylopectin and combinations thereof, or also comprising polyethylene, a fluorinated binder, for example a compound chosen among polyvinylidene fluoride (PVDF), poly(vinylpyrrolidone), polytetrafluoroethylene (PTFE), ethylene chlorotrifluoroethylene (ECTFE), polyethylene tetrafluoroethylene (ETFE), fluorinated ethylene propylene (FEP), perfluoro-alkoxy (PFA), polychlorotrifluoroethylene (PCTFE), fluoracrylates, fluorosilicones and combinations thereof.

Also advantageously, the composition T according to the invention can also comprise at least one organic acid or one mineral acid, preferably an acid chosen among sulphuric acid, phosphoric acid, phosphorous acid, hypophosphorous acid, acetic acid and combinations thereof.

Essentially according to the invention, the aqueous composition T comprises at least one material E. Preferably according to the invention, the composition T comprises a material E chosen among silicon, lithium, carbon graphite or graphitic carbon, hexagonal carbon, rhombohedral carbon and combinations thereof, optionally doped with at least one element, preferably chosen among lithium, germanium, silicon and combinations thereof.

The preferred material E is chosen among carbon graphite, silicon and combinations thereof.

In particular, the material E can be chosen among a conductive carbon compound, furnace black, acetylene black, Ketjen carbon black, carbon nanotubes (CNTs), synthetic graphite, natural graphite, hard carbon, activated carbon, carbon black, graphene, mesoporous carbon, amorphous silicon, semi-crystalline silicon, silicon oxides, silicon nanowires, tin, tin oxides, germanium, lithium titanate, materials suitable for use as an anode in a lithium-ion battery and combinations thereof.

According to the invention, material E can include conductive materials or materials capable of intercalating or accepting lithium ions.

Advantageously according to the invention, composition T may also include other ingredients. In particular, the composition T according to the invention can also comprise polyethylene, a fluorinated binding compound, for example a compound chosen among polyvinylidene fluoride (PVDF), poly(vinyl-pyrrolidone), polytetrafluoroethylene (PTFE), chlorotrifluoroethylene (ECTFE), polyethylene tetrafluoroethylene (ETFE), fluorinated ethylene propylene (FEP), perfluoroalkoxy (PFA), polychlorotrifluoroethylene (PCTFE), fluoracrylates, fluorosilicones and combinations thereof.

Within the composition T, the proportions of the various ingredients can vary. Preferably, the composition T according to the invention comprises:
from 0.5% to 15% by dry weight of binding agent, in particular of binding agent L, and
from 85% to 99.5% by dry weight of material E, relative to the total amount by dry weight of binding agent and of material E.

The invention also provides a method for preparing an aqueous composition T. The preparation method comprises:
the preparation of a binding agent L according to the invention,
the addition of at least one material E chosen among metal fibres, metal particles, carbon graphite fibres, carbon graphite particles and combinations thereof, preferably material E is chosen among silicon, lithium, carbon graphite or graphitic carbon, hexagonal carbon, rhombohedral carbon and combinations thereof, optionally doped with at least one element, preferably chosen among lithium, germanium and combinations thereof.

The invention also provides a method for producing an anode using a composition T according to the invention. The anode production method comprises:
the application of at least one composition T according to the invention onto a substrate,
drying and then calendering the coated substrate.

Advantageously according to the invention, the substrate or current collector can be in the structural form of a plate, a film, a mesh, a foam, a sheet, a rod or any other form that does not significantly impair its ability to collect electric current. Generally, the substrate is in the form of a sheet, preferably a sheet of copper metal (Cu⁰) or a sheet of nickel metal (Ni⁰).

Preferably, the invention provides a production method according to the invention in which the application is carried out at a pH of less than 7 or at a pH ranging from 4 to 6.5. Also preferably, the invention provides a production method according to the invention in which the application of the composition T to the substrate is carried out on a metal surface to a thickness after drying and calendering that is less than 500 μm, preferably less than 100 μm or less than 50 μm. Generally according to the invention, the thickness of the composition T after application to the substrate, drying and calendering is greater than 5 μm. According to the invention, the thickness of the composition T after application to the substrate, drying and calendering is measured using a coating thickness gauge of from 1 μm to 1,000 μm, in particular from 20 μm to 30 μm. Particularly preferably, the invention provides a production method in which the application of the composition T to the substrate is uniform. According to the invention, the composition is applied uniformly when the particles of material E are evenly distributed in the layer. According to the invention, uniformity is measured by visual inspection through direct observation with the naked eye.

According to the invention, the application is uniform when no aggregates are visible on the surface of the layer when viewed from the front in daylight.

Preferably when producing an anode according to the invention, at least one of the application steps is carried out at a pH of less than 7, preferably at a pH of less than 5.

The composition T according to the invention is applied by a method known as such. It can be applied by spraying, rolling, coating, heliogravure or any other means of applying an aqueous formulation to a surface.

The invention makes it possible to produce an anode using the composition T according to the invention. Thus, the invention provides an anode prepared according to the production method according to the invention.

According to the invention, the particular, advantageous or preferred characteristics of the composition T according to the invention define preparation methods, production methods and anodes according to the invention which are also particular, advantageous or preferred.

The following examples illustrate the various aspects of the invention.

### EXAMPLES

### Preparation and Characterisation of a Binding Agent L Comprising the Polymer P1 According to the Invention

90 g of acrylic acid (monomer a), 10 g of ethyl acrylate (monomer b) and 830 g of deionised water are introduced into a 1 L glass reactor with mechanical stirring and oil bath heating. This is heated to 70° C. A solution comprising 0.50 g of ammonium persulphate in 10 g of deionised water is then poured in all at once. The temperature is kept at 85° C. for 60 minutes. A solution comprising 0.20 g of ammonium persulphate in 10 g of deionised water is again poured in all at once. The temperature is kept at 85° C. for 60 minutes. After cooling to room temperature, the pH is adjusted to 2.5 by adding a 50% by weight aqueous sodium hydroxide solution. This results in a water-soluble binding agent L according to the invention comprising the copolymer P1 with a weight-average molecular mass Mw, measured by SEC, of 165,000 g/mol in aqueous solution with a concentration of 11.2% by weight.

Preparation and Characterisation of a Binding Agent L Comprising the Polymer P2 According to the Invention 90 g of acrylic acid (monomer a), 10 g of ethyl acrylate (monomer b) and 820 g of deionised water are introduced into a 1 L glass reactor with mechanical stirring and oil bath heating. This is heated to 70° C. A solution comprising 0.35 g of ammonium persulphate in 10 g of deionised water is then poured in all at once. The temperature is kept at 85° C. for 60 minutes. A solution comprising 0.35 g of ammonium persulphate in 20 g of deionised water is again poured in all at once. The temperature is kept at 85° C. for 60 minutes. After cooling to room temperature, the pH is adjusted to 5.7 by adding 39.4 g of LiOH·H₂O in 40 g of deionized water.

This results in a water-soluble binding agent L according to the invention comprising the copolymer P2 with a weight-average molecular mass Mw, measured by SEC, of 256,000,000 g/mol in aqueous solution with a concentration of 10.4% by weight.

### Preparation of Aqueous Anode Compositions T According to the Invention

An aqueous composition comprising 5% by dry weight of polymer P1 and 5% by dry weight of carbon black (Black C65 “Imerys”) is prepared with the binding agent L comprising the polymer P1 (11.2% by weight), under stirring for 2 hours at 3,000 rpm using a stirrer fitted with a 40 mm disc wheel.

Then, 0.32 g of this aqueous composition of carbon black and of polymer P1, 1.2 g of silicon particles (SI-100 30-50 nm, “Get Nano Materials”) and of deionised water are introduced into a glass beaker, under stirring for 1 hour at 4,500 rpm using a stirrer fitted with a 25 mm disc wheel. 6.32 g of a mixture of graphites (GHDR 92.5% by weight, SFG15L 5% by weight, KS6L 2.5% by weight, “Imerys”) and deionised water are added. Stirring is continued for 1 hour. 0.4 g of styrene-butadiene binding latex (SNR BM-451B “Zeon” latex, 40% by weight) is then added and stirred for 30 minutes at 500 rpm. The amounts of water added are defined to obtain an aqueous anode composition T1 according to the invention with a final concentration by dry weight of 44.6%.

Similarly, the aqueous anode composition T2 according to the invention is prepared, which also has a final concentration of 44.6% by dry weight. It comprises the binding agent L according to the invention comprising the copolymer P2 (10.4% by weight).

### Production and Characterisation of Anodes According to the Invention

A 100 μm-thick copper sheet is coated with a 20 μm-thick layer of composition T1 according to the invention, using a manual application bar. Discs with a diameter of 15 mm are cut out using a precision cutter. The coated discs are calendered at 0.6 t/cm² using a press. The discs are then dried in an oven, gradually increasing the temperature to 110° C. under vacuum for 18 hours.

After cooling to room temperature, the uniformity of the layer is assessed by visual inspection: no aggregates or surface unevenness are visible on the surface of the layer when viewed from the front in daylight.

The density of the resulting anode is then measured by weighing it on a balance, then its porosity is calculated.

An anode is similarly prepared and characterised using the aqueous anode composition T2. The results are shown in Table 1.

TABLE 1

| Polymer | Density (g/cm3) | Porosity (% vol.) |
|---|---|---|
| P1 | 1.8 | 18 |
| P2 | 1.8 | 22 |

The aqueous anode compositions comprising the binding agents according to the invention therefore make it possible to prepare anodes that are stable and in which the active materials bond well to the copper layer. The anode compositions according to the invention make it possible to prepare anodes with a uniform layer. These anodes can therefore be easily used to produce rechargeable cells or secondary batteries.

### Production and Characterisation of Half-Cells Comprising Anodes According to the Invention

In a glovebox (“MBraun LabStar”) kept in an inert atmosphere (Ar, O₂ and H₂O<0.5 ppm), the electrolyte (“Solvionic” 1M, LiPF₆ in an ethylene carbonate-ethyl methyl carbonate mixture with 2% of vinyl carbonate and 10% of fluoro ethylene carbonate), an anode according to the invention, a pre-cut lithium disc (15.6 mm in diameter and 0.25 mm thick) then a separator disc (“Whatman” GF/C 1822-849, 17 mm in diameter, 0.26 mm thick and 1.2 μm pore size) and a separator disc (“Celgard” 2325 tri-layer PE/PP/PE) are assembled on the working electrode.

The half-cell including the anode according to the invention, prepared with the aqueous anode composition T2a, is subjected to charge-discharge cycles in athermostatted chamber at 25° C.:
2 cycles: C/7 discharge to 0.005 V with C/100 cut-off, then C/7 charge with 1.0 V cut-off,
3 cycles: C/5 discharge to 0.005 V with C/50 cut-off, then C/5 charge with 1.0 V cut-off,
102 cycles: 1 C discharge to 0.005 V with C/40 cut-off, then 1 C charge with 1.0 V cut-off.

A half-cell including the anode according to the invention is similarly prepared and characterised with the aqueous anode composition T2. For each half-cell, the charge (loading), capacity, initial coulombic efficiency (ICE), coulombic efficiency after 10 cycles and then after 20 cycles (CE10, CE20), coulombic cycling efficiency—CCE1, capacity retention relative to the first cycle after 10 cycles and then after 20 cycles (CR10, CR20) are determined. The results are shown in Table 2.

| | | | | CE10 | CE20 | | CR10 | CR20 |
|---|---|---|---|---|---|---|---|---|
| | Charge | Capacity | ICE | cycles | cycles | CCE1 | cycles | cycles |
| Polymer | (mAh/cm²) | (mAh/g) | (%) | (%) | (%) | (%) | (%) | (%) |
| P1 | 2.9 | 734 | 86.9 | 99.12 | 99.27 | 74.1 | 99.65 | 99.69 |
| P2 | 3.1 | 760 | 88.6 | 98.85 | 99.03 | 76 | 99.75 | 99.81 |

The binding agents according to the invention make it possible to prepare aqueous anode compositions that are highly effective for obtaining anodes and cells with high silicon concentration and whose electrochemical properties are particularly interesting.

1. An aqueous anode composition T, comprising:
0.5% to 15% by dry weight of a binding agent L comprising a water-soluble polymer P, with a weight-average molecular mass Mw, measured by SEC, of 2,000 g/mol to 1,000,000 g/mol, prepared in the presence of an initiator compound, by a polymerisation reaction of 20 to 95% by weight of at least one anionic monomer (a) selected from the group consisting of an acrylic acid, an acrylic acid salt, a methacrylic acid, a methacrylic acid salt, and combinations thereof or 5 to 80% by weight of a C₁-C₈ ester (b) of a compound derived from an acid selected from the group consisting of an acrylic acid, a methacrylic acid, a maleic acid, an itaconic acid, and a crotonic acid, relative to a total amount by weight of the anionic monomer (a) and the C₁-C₈ ester (b); and
85% to 99.5% by dry weight of a material E comprising at least one selected from the group consisting of a metal fiber, a metal particle, a carbon graphite fiber, a carbon graphite particle, and a silicon particle relative to a total amount by dry weight of the binding agent L and of the material E.

2. The aqueous anode composition T according to claim 1, wherein the anionic monomer (a) is selected from the group consisting of an acrylic acid, a methacrylic acid, and combinations thereof the anionic monomer (a) is combined with an other anionic monomer, different from the anionic monomer (a), and selected from the group consisting of an acrylic acid, a methacrylic acid, an acrylic acid salt, a methacrylic acid salt, a maleic acid, a maleic acid salt, an itaconic acid, an itaconic acid salt, a crotonic acid, a crotonic acid salt, an acrylic acid oligomer, and combinations thereof.

3. The aqueous anode composition T according to claim 1, wherein the C₁-C₈ ester (b) is not an alicyclic C₁-C₈ ester or the C₁-C₈ ester (b) is a C₁-C₇ ester, a C₁-C₆ ester, or a C₁-C₄ ester, or
the C₁-C₈ ester (b) is an acrylic acid ester or a methacrylic acid ester, or
the C₁-C₈ ester (b) is selected from the group consisting of a methyl acrylate, an ethyl acrylate, a propyl acrylate, a butyl acrylate an ethyl hexyl acrylate, a methyl methacrylate, an ethyl methacrylate, a propyl methacrylate, a butyl methacrylate, an ethyl hexyl methacrylate, and combinations thereof.

4. The aqueous anode composition T according to claim 1, wherein a single polymerisation reaction is carried out or the polymerisation reaction is carried out with a cross-linking monomer (c) or a cross-linking monomer (c) comprising at least two olefinic unsaturations, or
a hydrophobic monomer (d) different from the cross-linking monomer (c),
a compound (e) selected from the group consisting of phosphated hydroxyethyl acrylate, a phosphated hydroxypropyl acrylate, a phosphated hydroxyethyl hexyl acrylate, a phosphated hydroxyethyl-methacrylate, a phosphated hydroxypropyl-methacrylate, a phosphated hydroxyethyl hexyl-methacrylate, their salts and combinations thereof, or
a compound (f) selected from the group consisting of a hydroxyethyl acrylate, a hydroxypropyl acrylate, a hydroxyethylhexyl acrylate, a hydroxyethyl methacrylate, a hydroxypropyl methacrylate, and a hydroxyethylhexyl methacrylate.

5. The aqueous anode composition T according to claim 1 wherein the polymer P is prepared in the presence of at least one initiator compound selected from the group consisting of a peroxide, a hydroperoxide, a persulphate, combinations thereof, and associations thereof with a metal salt, or
the polymer P is prepared in the presence of a chain transfer agent, or
the polymer P has a pKa of less than 5, or
the polymer P is non-neutralised or the polymer P is completely or partially neutralised.

6. The aqueous anode composition T according to claim 1, wherein the polymerisation reaction is conducted with 30 to 70% by weight of the anionic monomer (a) or 30 to 70% by weight of the C₁-C₈ ester (b), relative to the total amount by weight of the anionic monomer (a) and the C₁-C₈ ester (b).

7. The aqueous anode composition T according to claim 1, wherein the polymer P has a weight-average molecular mass Mw, measured by SEC, of less than 900,000 g/mol or
the polymer P has a weight-average molecular mass Mw, measured by SEC, greater than 5,000 g/mol.

8. The aqueous anode composition T according to claim 1, wherein the aqueous anode composition T comprises the binding agent L and no other binding agent, or
the aqueous anode composition T further comprises an other binding agent, different from the binding agent L
the composition T further comprises an organic acid or one mineral acid.

9. The aqueous anode composition T according to claim 1, wherein the material E is selected from the group consisting of a silicon, a lithium, a carbon graphite or graphitic carbon, a hexagonal carbon, a rhombohedral carbon, and combinations thereof and optionally doped with at least one element.

10. The aqueous anode composition T according to claim 9, further comprising:
0.5% to 15% by dry weight of the binding agent L; and
85% to 99.5% by dry weight of the material E,
relative to a total amount by dry weight of the binding agent L and of the material E.

11. A method for preparing the aqueous anode composition T of claim 1, comprising:
preparing the binding agent L;
adding at least one material E selected from the group consisting of a metal fiber, a metal particle, a carbon graphite fiber, and a carbon graphite particle and optionally doped with at least one element.

12. A method for producing an anode, comprising:
applying the aqueous anode composition T of claim 1 to a substrate to obtain a coated substrate;
drying the coated substrate; and
calendering the coated substrate.

13. The method according to claim 12, wherein the applying comprises applying the aqueous anode composition T to the substrate at a pH of less than 7, or
the substrate is a metal surface and the coated substrate has a thickness after drying and calendering, measured using a coating thickness gauge of from 1 μm to 1,000 μm, that is less than 500 μm, or
the coated substrate has a thickness of greater than 5 μm after drying and calendering, measured using a coating thickness gauge of 1 μm to 1,000 μm, or
the applying comprises applying the aqueous anode composition T uniformly to the substrate.

14. An anode prepared according to the method of claim 12.

15. The aqueous anode composition T according to claim 2, wherein the C₁-C₈ ester (b) is not an alicyclic C₁-C₈ ester or the ester (b) is a C₁-C₇ ester, or a C₁-C₆ ester, or a C₁-C₄ ester, or
the C₁-C₈ ester (b) is an acrylic acid ester or a methacrylic acid ester, or
the C₁-C₈ ester (b) is selected from the group consisting of a methyl acrylate, an ethyl acrylate, a propyl acrylate, a butyl acrylate, an ethyl hexyl acrylate, a methyl methacrylate, an ethyl methacrylate, a propyl methacrylate, a butyl methacrylate, an ethyl hexyl methacrylate, and combinations thereof.

16. The aqueous anode composition T according to claim 1, wherein a single polymerisation reaction is carried out or the polymerisation reaction is carried out with a cross-linking monomer (c) or a cross-linking monomer (c) comprising at least two olefinic unsaturations, or
a hydrophobic monomer (d) of formula I, different from the cross-linking monomer (c)

| | |
|---|---|
| R¹-(EO)ₘ-(PO)ₚ-R² | (I) |

wherein
m and p, identical or different, independently represent 0 or an integer or decimal less than 150, m or p is different from 0,
EO independently represents a CH₂CH₂O group,
PO independently represents a group chosen among CH(CH₃)CH₂O and CH₂CH(CH₃)O,
R¹ independently represents a group comprising a polymerisable olefinic unsaturation, and
R² independently represents a straight or branched C₆-C₄₀-alkyl group, a phenyl group, a polyphenyl group, or a group comprising 2 to 5 phenyls, a tristyrylphenyl group, or a pentastyrylcumylphenyl group, or
a compound (e) selected from the group consisting of a phosphated hydroxyethyl acrylate, a phosphated hydroxypropyl acrylate, a phosphated hydroxyethyl hexyl acrylate, a phosphated hydroxyethyl-methacrylate, a phosphated hydroxypropyl-methacrylate, a phosphated hydroxyethyl hexyl-methacrylate, their salts and combinations thereof, or
a compound (f) selected from the group consisting of a hydroxyethyl acrylate, a hydroxypropyl acrylate, a hydroxyethylhexyl acrylate, a hydroxyethyl methacrylate, a hydroxypropyl methacrylate, a hydroxyethylhexyl methacrylate.

17. The aqueous anode composition T according to claim 2, wherein the polymer P is prepared in the presence of at least one initiator compound selected from the group consisting of a peroxide, a hydroperoxide, a persulphate, combinations thereof, and associations thereof with a metal salt, or
the polymer P is prepared in the presence of a chain transfer agent, or
the polymer P has a pH of less than 12, or
the polymer P has a pKa of less than 5, or
the polymer P is non-neutralised or the polymer P is completely or partially neutralised.

18. The aqueous anode composition T according to claim 3, wherein the polymer P is prepared in the presence of at least one initiator compound selected from the group consisting of a peroxide, a hydroperoxide, a persulphate, combinations thereof, and associations thereof with a metal salt, or
the polymer P is prepared in the presence of a chain transfer agent, or
the polymer P has a pH of less than 12, or
the polymer P has a pKa of less than 5, or
the polymer P is non-neutralised or the polymer P is completely or partially neutralised.

19. The aqueous anode composition T according to claim 4, wherein the polymer P is prepared in the presence of at least one initiator compound selected from the group consisting of a peroxide, a hydroperoxide, a persulphate, combinations thereof, and associations thereof with a metal salt, or
the polymer P is prepared in the presence of a chain transfer agent, or
the polymer P has a pH of less than 12, or
the polymer P has a pKa of less than 5, or
the polymer P is non-neutralised or the polymer P is completely or partially neutralised.

20. The aqueous anode composition T according to claim 2, wherein the polymerisation reaction is conducted with 30 to 70% by weight of the anionic monomer (a) or 30 to 70% by weight of the C₁-C₈ ester (b), relative to a total amount by weight of the anionic monomer (a) and the C₁-C₈ ester (b).
